(19) United States
(12) Patent Application Publication
(10) Pub. No.: US 2009/0189763 A1
(43) Pub. Date: Jul. 30, 2009

(54) Security film

(76) Inventors: Kenneth Brinkley, Owenton, KY (US); Robert Ufer, Punto Gorda, FL (US)

Correspondence Address: Richard B. Klar;Law Office of Richard B. Klar, Suite #6, 145 Willis Avenue, Mineola, NY, 11501, US

(21) Appl. No.: 12/321,941

(22) Filed: Jan. 27, 2009

Related U.S. Application Data
(60) Provisional application No. 61/062,628, filed on Jan. 28, 2008.

(51) Int. Cl. G08B 13/00

(52) U.S. Cl. 340/541

(57) ABSTRACT

A tamper indication device has a film attached and connected within the circuit that generates a signal in response to a tamper event. The signal is received by a micro-controller which generates an output signal to a display or data collection device and transceiver. More particularly, the tamper indication device has a printed circuit in a specialized pattern to make entry without breaking the circuit near impossible. When the circuit is broken a signal is counted by the micro controller which generates an output signal for delivery to a display or other data collection device. The output signal can be transmitted by RF device such as a passive or active RFID Tag, or by an IR communications device or by any other communication variant.

### BACKGROUND

The present disclosure relates generally to a flexible security film and monitoring device that can detect and provide a real time alert, signaling the film has been tampered with or penetrated.

It is highly desirable to have an accurate method of determining and signaling exactly when tampering or penetration occurs. It is often difficult to accomplish this without triggering false alarms; items protected using current technology only tell you they were tampered with after they have been received and the tamper indicator has been inspected. They do not signal that they have been tampered with at the time of occurrence.

Security concerns exist for all types of packaging that contains high value items/goods, envelopes, crates, containers, or pallets that are shipped by carriers, air ship etc. All goods are susceptible to pilfering or tampering during transport or storage in unsecured areas.

To date there have been various attempts to provide monitoring and security. The use of dye when exposed to air changes color to let one know if someone has compromised the envelope or package. This provides a tamper indicator that has a small deterrent factor for honest employees.

However, these approaches do nothing for the user but to let the user know someone has tampered with the user's goods, which would be discovered upon opening the goods anyway.

Some of these approaches can result in a false trigger leaving the user with doubt in the carrier's ability to properly handle the package.

### SUMMARY

The present disclosure seeks to overcome the aforementioned drawbacks of the prior art proposal by utilizing a low cost RFID unit in concert with the film to send an instantaneous alert the moment tampering occurs. This greatly increases the chance of recovery and identifying the weak links in the system that plague the company with unnecessary loss at the high cost of loss of revenue and reputation. Additionally, the films unique properties are used with a communication link that can utilize a variety of RF technologies such as, but not limited to, passive and active RFID Tags and also use hard wired communications to name a few.

The present disclosure provides for a tamper indication film that is responsive to a variety of tampering methods. A tamper indicative film can provide an output as a visually or audibly perceptible display or as a feed to a data collection system such as a computer. It can provide a tamper indication that can be used on different sized envelopes and containers.

It can provide a tamper indication in remote areas using cellular or other communication links to provide remote security. Utilizing the security film which can be formed by way of illustrative but non-limiting example by a wall paper like material or tape, a user has the ability the provide low power to the tamper indicative device of the present disclosure, for example with an AA size lithium battery that could provide 24 hour security to the item it is attached to for ten years. Alternatively, a printable battery can be used. If the RFI Tags are passive the charge for the RFID Tag can be induced.

The tamper security device of the present disclosure that can be used for small packages is independent of other security systems such as those utilized for an office building or a house where the packaged item in question—the item for which the tamper security device is to be attached to—is located. Thus an authorized user may disable the home or office security to permit someone else to have access within the location where the item to be protected by the tamper security device is located but still have security control via the tamper security device over that particular item. This eliminates pilfering by limiting access to the personal item. Studies have shown that 90% of most thefts are opportunistic.

Additional objects, advantages and other novel features will be set forth in part of the description that follows and in part will become apparent to those skilled in the art upon examination of the following or maybe learned with practice of the present disclosure.

As described herein, there is a tamper indication device having a film attached and connected within the circuit that generates a signal in response to a tamper event. The signal is received by a micro-controller which generates an output signal to a display or data collection device and transceiver. The output signal can take information from a variety of different sensor types, i.e., shock, vibration, temperature and security breach information and display it in a data collection device.

Still other objects of the present disclosure will become apparent to those skilled in this and from the following description wherein there is shown and described in the preferred embodiment of this invention, simply by the way of illustration of one of the best modes contemplated for carrying out the present disclosure. As will be realized, the present disclosure is capable of different embodiments, and its several details are capable of modification in various, obvious aspects all without departing from the invention. Accordingly, the drawings and descriptions will be regarded as illustrative in nature and not as restrictive.

Reference will be made in detail to the present preferred embodiment(s) of the invention, an example of which is illustrated in the accompanying drawings

### BRIEF DESCRIPTION OF THE DRAWINGS

FIG. 1 is a perspective view of a tamper indication device incorporated into an enclosure such as bag or a pouch according to the present disclosure;

FIG. 2 is a perspective view of a transponder or RFID Tag device 7 of FIG. 1;

FIG. 3A is a portion of the two sided tape 3 showing one side of the housing 4 for the transponder 7 or RFID Tag 7 mounted thereon where the contact pads 5 are shown; and

FIG. 3B is a portion of the two sided tape 3 showing another side of the housing 4 for the transponder or RFID Tag 7 mounted behind the two side tape 3 with battery 6 and RFID Tag 7 showing in visible lines behind the tape 3 thereon where the contact pads 5 are shown;

FIGS. 4A, B and C show an embodiment of the present invention in which the tamper indication device is placed in goods on a pallet.

### DETAILED DESCRIPTION OF THE PREFERRED EMBODIMENTS

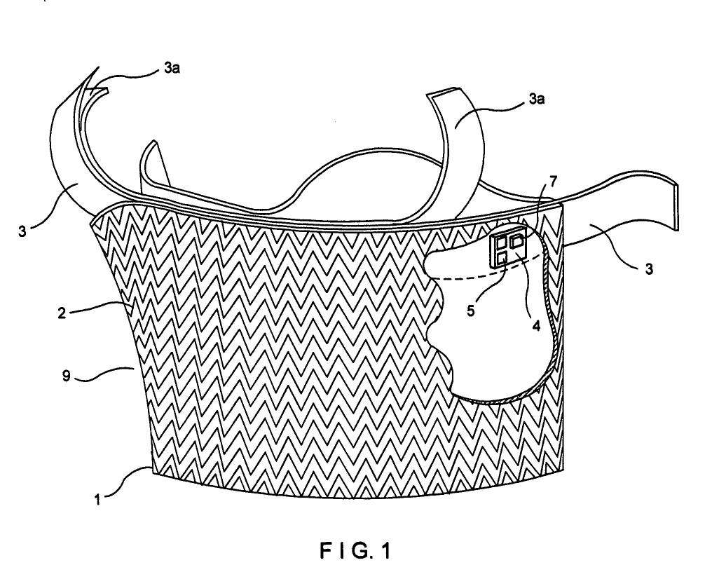

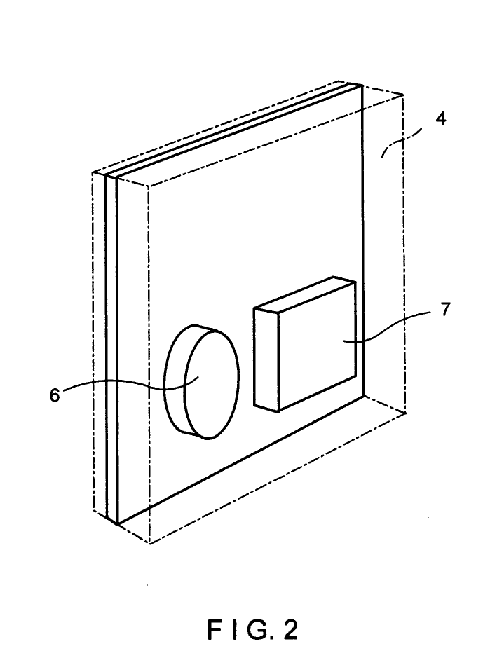

Referring now to the drawings in detail, wherein like numerals indicate the same elements throughout the views, FIG. 1. shows a diagrammatic representation of the various components of a tamper indication device constructed in accordance with the present invention. The tamper indication device 1, includes a sensing element formed as a conductive patterned printed layer of film laminate 2 (shown by way of non-limiting illustrative example in a zig zag pattern in FIG. 1), a two-sided conductive tape 3, a RFID passive or active Tag 7, a peel off adhesive strip (3a) to close the circuit, component pad on the RFID Housing 4, a battery 6 (shown in FIG. 2 and not shown in FIG. 1). Peeling off the adhesive conductive strip 3a serves two purposes: first, it seals an enclosure such as the security pouch or bag 9 shown in FIG. 1 and second, it completes the circuit between the tamper indication device 1 and the RFID Tag. 7 It is understood that the present disclosure is not limited to any particular enclosure and the embodiment shown in FIG. 1 is a non-limiting illustrative example of the type of enclosure for which the invention can be utilized. When a Passive RFID Tag 7 is used an authorized user can detect a circuit break by passing the tamper indication device 1 (Security Film) through a data collection device, such as an RFID Reader, from point to point. When the RFID Tag 7 is an active Tag the sealing of the security film using the conductive strip completes the circuit and starts a clock in the active Tag 7; it can also activate other sensors in conjunction with it such as one or more GPS units. When the circuit or security envelope or other barrier is broken, the system provides an instantaneous alert via the Active RFID Tag 7. The RFID Tag 7 is connected to the film laminate 2. The conductive adhesive tape 3 seals the pouch when the peel off strip 3a is removed. The film laminate surrounds the pouch on the front and rear surfaces so that tampering such as a tear or rip will be detected as well as an opening of the pouch where sealed by the adhesive from the peel off strip. When such tampering occurs the active RFID Tag 7 will send a signal to a data collection device informing a person at the data collection site of the tampering of the pouch. The conductive pads 5 preferably are adhesively coated to provide an adhesive for where the pads 5 connect with the bag or pouch 9. The side of the housing 4 where the RFID Tag 7 or the transponder 7 is located can also be adhesively coated for an adhesive contact with the back side of the two sided tape 3 or alternatively, if preferred, with the bag or pouch 9. It is possible to use more than one RFID Tag 7 or transponder 7 if desired.

FIG. 2 illustrates the housing for the RFID Tag of the embodiment in FIG. 1. The housing 4 includes on of its faces a battery 6 and an RFID Tag 7.

The tamper indication device 1 in FIG. 1 generates an electrical signal, such as the breaking of an electrical circuit in response to each time the film is penetrated, which occurs when the object enclosed, is tampered with. The film laminate 2 is electrically connected to the RFID Tag 7 via pads 5 connected to housing 4, and is adapted to detect a break in the circuit causing the RFID Tag 7 to generate an output signal either by, to a data collection device in response to receipt of this signal. Battery 6 provides power to the tamper indication device 2. This RFID Tag 7 as noted herein can alternatively be a microcontroller or any other transponder where the transmission of the signal can be sent by RF, IR or inductively transmitted.

Referring to FIG. 2, the tamper indication sensing assembly 1, shown in section view, that can be inserted into a housing such as an envelope or alternatively as shown in the tamper sensing assembly 2 can be formed integrally with the housing 1 (as shown in FIG. 1) or can be employed separately by using the tape 3 with the transponder 7 or RFID Tag 7 for a door that is opened or tampered with, etc. A sensor element is electronically connected to the micro-controller or RFID Tag 7. The tamper indication device 1 detects unauthorized users, but preferably not in response to authorized users. Preferably, this electrical circuit is closed only once when the items are placed internally within the protective security film. An AA lithium battery 6, by way of non-limiting illustrative example, can be attached and could provide power to the device and security for 10 years. Alternatively, a printable battery can be used. If the RFID Tags 7 are passive the charge for the RFID Tag can be induced. A printable battery or for a passive RFID Tag 7 inductive charge can be used for the embodiment of FIG. 1 as well.

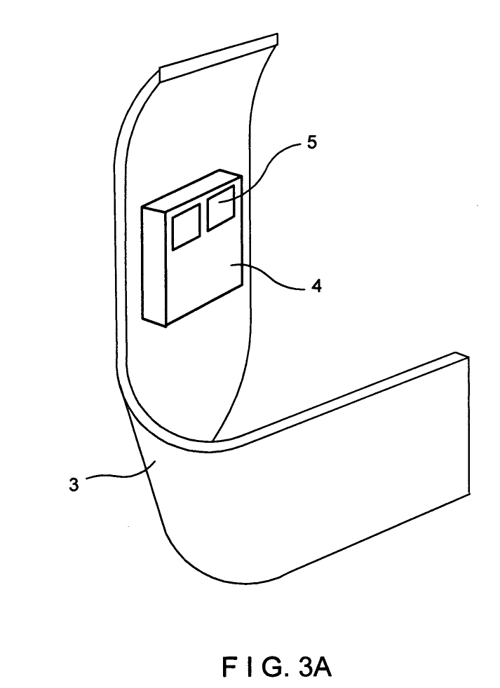

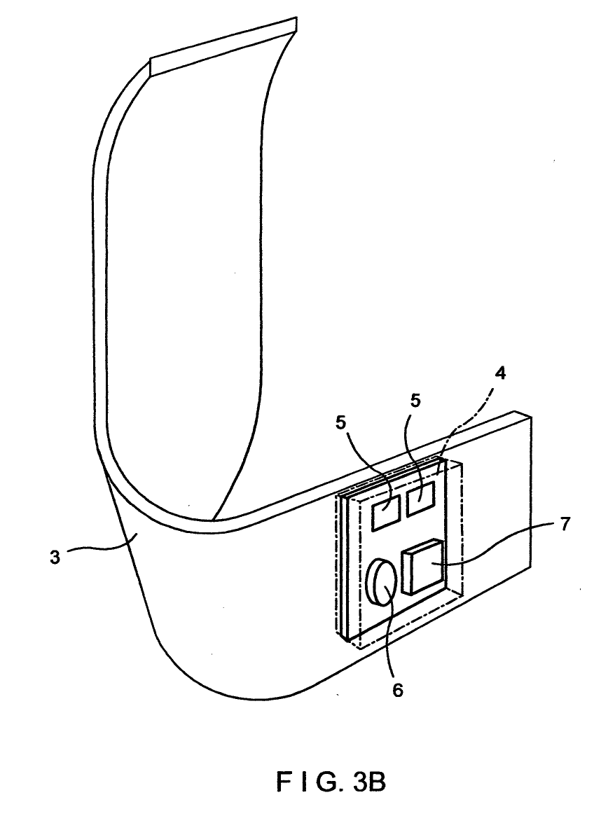

FIGS. 3A and 3B show the two sides of the housing 4 for the transponder 7 that is mounted on the two sided tape 3. In FIG. 3A the housing 4 is shown in which the contact pads 5 are located on the transponder or RFID Tag 7. The side of the pads 5 makes electrical contact with and are preferably adhesively applied to the bag or pouch 1 to make and close the circuit with the film laminate 2.

It is understood that the present disclosure is not limited to enclosures protected by the tamper indication device 1 of the present disclosure but can include any other item that one wishes to protect by providing the mechanism of the present disclosure for alerting someone when that item is being tampered with and also storing the tampering information within the transponder.

The film laminate 2 can be formed by printable conductive ink that can be printed on any surface including but not limited to Mylar film, plastic, flexible material, cloth etc. The ink would preferably have the following characteristics or attributes: a viscosity 12,000 CPS @30 C; a total solids content 61%; a density 17 lbs/gal; a flash point 212 F; VOC 794 grams of solvent/liter; an electrical resistance<0.015 ohms/square @1.0 Mil; and an electrical resistance<0.015 ohms/square @25.4 microns.

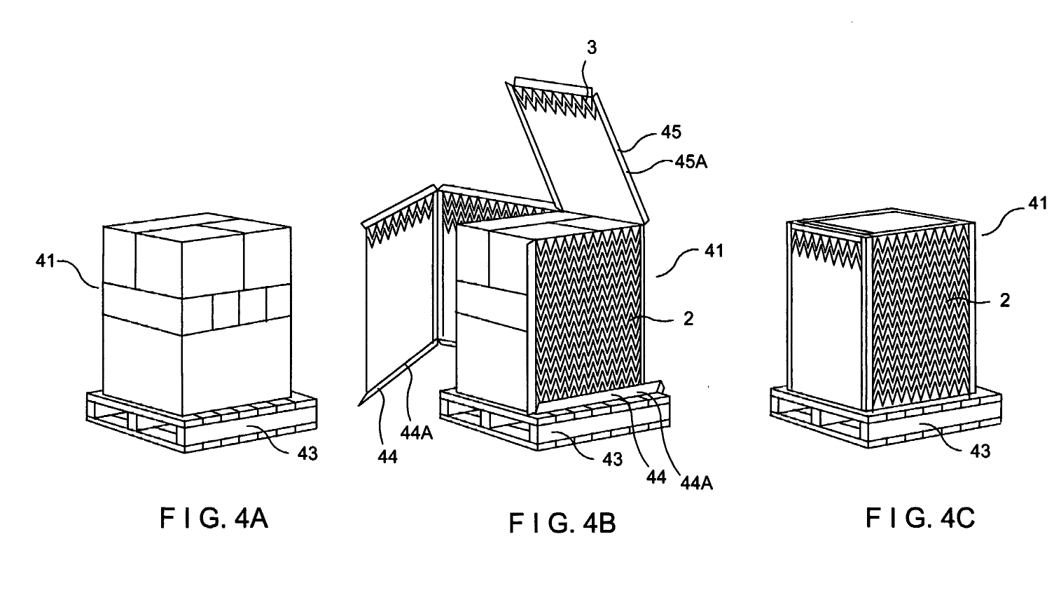

An embodiment of the present disclosure would be for palletized goods as shown in FIGS. 4A, 4B and 4C where a flexible fabric type material or film laminate 2 with the conductive ink printed thereon and connected to the transponder (not shown) as described for FIGS. 1 and 2 would be placed over a container or box 41 for goods on a pallet 43 and the flexible fabric type material 2 would be stretch wrapped, shrunk wrapped, banded or covered by a box or container 41 to keep the goods in place. The box 41 would have flaps such as flaps 44 and 45 as shown in FIG. 4B in which electrically conductive double sided tape 3 would be placed on a face 44a for flaps 44 and 45a for flap 45 and peeled off and then flap 44 would be paced against the side of the pallet 43 to and flap 45 against the top surface of 46 of box 41 to seal the circuit in place so that a breach can be detected. It is noted that allowance is made for holes on the side of 43a where flaps 44 are placed for fork lifting the pallet 43 without breaching the tamper indication device 1 by allowing holes in the flap 44 that do not trigger the system. If the fabric or film laminate 2 is penetrated or opened to gain access to the goods this intrusion would be detected and a signal sent out.

There are numerous types of outputs possible with the open architecture designed into the system. It can easily be configured to provide audible alerts as well as silent alerts within microseconds of the unauthorized event/entry into FIG. 1. Inside the tamper indication device housing contains all the necessary hardware and communication capability that interfaces with the film through a flex connector.

The tamper indication device 1 can be incorporated into a bullet proof vest acting as a sensor (not shown) for when a bullet penetrates the vest and sets off the security film by breaching it with the bullet's penetration therein. A police officer wearing a bullet proof vest may be able to have the vest stop the bullet from completely penetrating through his body; however, the officer still may suffer from trauma due to the impact from the bullet hitting the bullet proof vest and even knocking the officer over causing incapacitating injuries. If the police officer is working on a lone patrol, he may be hurt and unable to call for help due to the trauma suffered from bullet. Under these circumstances the tamper indication device of the present application works like a sensor not only detecting the bullet strike but also making it possible to determine the location of the bullet. This application of the tamper indication device of the present application works in the military as well as for providing a low cost bullet detection sensor.

Another embodiment is in the event an explosion or fire vision is often reduced to touch for both the evacuees and the rescuers. Exit signs during these emergencies just indicate a safe exit during the best circumstances. (No fire).

In the event you are in a multi floor building a fire or an explosion can make an exit unsafe and the closest exit may not be the best exit, but with no indication as it stands right now the wrong turn can be fatal.

The solution is to use the tamper indication device 1 as a sensor covering the floors, ceilings and the walls with its low power transceiver providing not only a security function, but also a wire frame of the interior of the building (not shown). With some logic you could turn the exit signs into smart exits indicating the best route to go and provide fire fighter-rescuers for the first time revolutionary near real time status of existing or remaining floors, walls and ceilings. The device can be incorporated into each corner of four corners of a building floor as wells as the ceiling and floor to detect breaches and alert someone as to where the breach is located specifically in the building.

While presently preferred embodiments have been described for purposes of the disclosure, numerous changes in the arrangement of method steps and apparatus parts can be made by those skilled in the art. Such changes are encompassed within the spirit of the invention as defined by the appended claims.

1. A device for monitoring and indicating when a flexible film has been tampered or penetrated by an unauthorized individual at a time of the tampering, comprising:
a tamper indication device having a tamper indication film attached thereto and connected within a circuit that generates a signal in response to a tamper event, and
a transponder for receiving said signal which generates an output signal to a display or data collection device and transceiver.

2. The device according to claim 1 wherein said transponder is a microcontroller.

3. The device according to claim 1 wherein said transponder is an RFID Tag.

4. The device according to claim 3 wherein said RFID Tag is an active RFID Tag.

5. The device according to claim 3 wherein said RFID Tag is a passive RFID Tag.

6. The device according to claim 1 wherein said device is incorporated into a bullet proof vest.

7. The device according to claim 1 wherein said device is located in goods on a pallet.

8. The device according to claim 1 wherein the device is located at least in one of a one or more corners, a ceiling or a floor of a building floor.
